(19) United States
(12) Patent Application Publication
(10) Pub. No.: US 2026/0316370 A1
(43) Pub. Date: Oct. 15, 2026

(54) FIBER REINFORCEMENT MATERIAL, METHOD OF MANUFACTURING FIBER REINFORCEMENT MATERIAL, MOLDED VEHICLE HEADLINER INCLUDING FIBER REINFORCEMENT MATERIAL, AND METHOD OF MANUFACTURING MOLDED VEHICLE HEADLINER

(71) Applicant: Sanwa Kogyo Co., Ltd., Hiroshima-shi (JP)

(72) Inventor: Masahiko MIKAMI, Hiroshima-shi, Hiroshima (JP)

(21) Appl. No.: 19/551,303

(22) Filed: Feb. 26, 2026

(30) Foreign Application Priority Data
Apr. 14, 2025 (JP) 2025-066506

(51) Int. Cl. B29C 51/12; B29K 23/00; B29K 105/00; B29K 105/12; B29K 309/08; B32B 1/00; B32B 5/24; B32B 7/12; B32B 37/06; B32B 37/10; B32B 37/12

(52) U.S. Cl. CPC B29C 51/12; B32B 1/00; B32B 5/245; B32B 7/12; B32B 37/06; B32B 37/10; B32B 37/1284; B29K 2023/083; B29K 2105/128; B29K 2105/251; B29K 2309/08; B32B 2250/05; B32B 2262/101; B32B 2266/0278; B32B 2305/022; B32B 2305/28

(57) ABSTRACT

The present disclosure is a fiber reinforcement material used for a thermoformed product which is a product thermoformed in a mold, the fiber reinforcement material includes: glass paper including glass fibers as a main material; and a slip-property imparting binder material adhering to the glass paper. The slip-property imparting binder material includes a thermoplastic resin, the thermoplastic resin softening, during thermoforming of the product, to enable the glass fibers to slip against each other to conform to a shape of the mold used in thermoforming the product, the thermoplastic resin solidifying after the thermoformed product is cooled.

### CROSS-REFERENCE TO RELATED APPLICATION

The present application is based on, and claims priority to Japanese Patent Application No. 2025-066506, filed Apr. 14, 2025, the disclosure of which is incorporated herein by reference in its entirety.

### BACKGROUND

### Technical Field

The present disclosure relates to a fiber reinforcement material used for a thermoformed product which is a product thermoformed in a mold, a method of manufacturing the fiber reinforcement material, a molded vehicle headliner including the fiber reinforcement material, and a method of manufacturing the molded vehicle headliner.

### Related Art

It is known that a headliner which is an interior part of a vehicle primarily uses a molded polyurethane headliner including a glass mat or glass paper as a fiber reinforcement material.

For example, a headliner known from Japanese Laid-Open Patent Application No. 2001-301539 A (hereinafter referred to as “Patent Literature 1”) includes, for example, a base material such as rigid polyurethane, glass fiber reinforcement layers disposed on opposite sides of the base material, respectively, a top layer on an outer side of one of the fiber reinforcement layers, and a back layer on an outer side of the other of the fiber reinforcement layers. In Patent Literature 1, as the glass fiber reinforcement layers, for example, glass mats coated (impregnated) with an adhesive including a polyurethane-based resin (e.g., an isocyanate-based resin) are used to reinforce the base material and to obtain the strength of adhesion to the top layer and the back layer.

A headliner including glass paper formed from glass fibers as an alternative to the glass mat is known. For example, Japanese Laid-Open Patent Publication No. 2012-162138 A (hereinafter referred to as “Patent Literature 2”) discloses a molded vehicle interior part including, for example, a base material such as rigid polyurethane, a first glass fiber reinforcement layer and a second glass fiber reinforcement layer disposed on opposite sides of the base material, respectively, a top layer on an outer side of one of the fiber reinforcement layers, and a back layer on an outer side of the other of the fiber reinforcement layers, wherein the first glass fiber reinforcement layer includes a glass mat, and the second glass fiber reinforcement layer includes glass paper.

Moreover, a document is known which discloses that a glass mat and glass paper stacked one on top of another are used as a fiber reinforcement material. For example, Japanese U.S. Pat. No. 7,104,447 (hereinafter referred to as “Patent Literature 3”) discloses a molded vehicle interior part including, for example, a base material such as rigid polyurethane, a first glass fiber reinforcement layer and a second glass fiber reinforcement layer disposed on opposite sides of the base material, respectively, a top layer on an outer side of one of the fiber reinforcement layers, a back layer on an outer side of the other of the fiber reinforcement layers, wherein the first glass fiber reinforcement layer includes a glass mat, and the second glass fiber reinforcement layer includes glass paper.

Also in the molded headliner, due to a functional and/or design requirement, a deep-drawn shape is more required for the molded headliner than ever before.

A molded polyurethane headliner generally includes a fiber reinforcement material including glass fibers, such as a glass mat or glass paper, as a material disposed on both surfaces of a polyurethane base material. However, the glass fibers themselves are not stretchable. Therefore, as the degree of deep drawing of the molded headliner increases, stretching and/or bunching occurs during molding the fiber reinforcement material, which may consequently influence the product quality of the top layer, which is a designed surface.

In the case of the glass mat as described in Patent Literature 1, about a hundred to a hundred and fifty glass filaments (single fibers) each generally having a thread diameter of about 9 μm to 13 μm are bundled and are cut to a fiber length of about 2 inches, thereby obtaining so-called glass chopped strands, which are then scattered on a flat surface and are bonded together with an adhesive, thereby manufacturing the glass mat. Therefore, the glass mat is in the shape of a mesh, and the coarseness of the mesh is not necessarily uniform.

Therefore, in the case of the molded headliner, a raised portion, for example, in the vicinity of an A-pillar part, having a highly contoured shape is locally stretched during molding, and the glass chopped strands slip against each other and forcibly release the bond therebetween, and the mesh has thus enlarged openings to conform to a change during the molding. Specifically, a glass mat having a grammage of 100 g/m² may locally have a grammage of about 50 g/m² depending on molded portions, but the glass mat is in the shape of the mesh and thus barely maintains the strength.

In contrast, in a deep-drawn portion, the bond between the glass chopped strands is not forcibly released, and a “stretching wrinkle” is formed in a state where the bond is about to be released. Moreover, in the vicinity of the deep-drawn portion, a “compression wrinkle” is formed. As a result, the top layer, which is a designed surface, has a significant defect, resulting in a product, which can thus not be marketed.

It can be seen that a change in a curved surface is significant, for example, at attachment portions of parts (e.g., such as sun visors, overhead consoles, passenger assist handles, and room lamps) and/or at joint portions to the A-pillar and a B-pillar. The stretching wrinkles and/or the compression wrinkles are formed at these portions, and when the wrinkles are severe, cracks may be formed at these portions in the base material, resulting in defective products (unusable products).

FIG. 4 is a photograph of a passenger assist handle part of a molded headliner manufactured by using a glass mat as the fiber reinforcement material. The molded headliner includes, as a base material, a thermoformable rigid polyurethane foam sheet (1200 mm×1600 mm×thickness 6.5 mm) having open cells of a weight per unit area of 195 g/m². Moreover, the molded headliner includes a top layer material which is non-woven fabric having a grammage of 180 g/m² and a back layer material which is a general laminate product of the non-woven fabric and a polypropylene (PP) film and has a grammage of 70 g/m².

Moreover, as the glass mat, which is the fiber reinforcement material, included in the molded headliner, a mat formed as follows is used: eighty or more glass filaments each having a diameter of 10 μm to 15 μm are bundled by using a sizing (filament coating) agent to obtain a fiber bundle of 0.8 mm to 1.5 mm, and the fiber bundle is cut to a length of about 30 mm to 80 mm, thereby manufacturing chopped strands, which are scattered in the shape of a mat and are formed into a mat by using a binder. The grammage of the glass mat is 100 g/m². To the glass mat is applied an isocyanate-based adhesive at an amount of 15 g/m² before compression-molding.

The molded headliner shown in FIG. 4 is obtained by: disposing the top layer material, the glass mat, the polyurethane foam sheet, the glass mat, and the back layer material described above in this order in a mold; and compression-molding these materials in the mold to bond these materials together. The molded headliner has a width of 1200 mm and a length of 1600 mm, and a total thickness including all materials constituting the headliner is 7.5 mm.

Examples of defects observed in the molded headliner molded by using the glass mat as the fiber reinforcement material include the “stretching wrinkle” and the “compression wrinkle”. Considering ease of viewing, a photograph of the passenger assist handle part at which a particularly significant “stretching wrinkle” is formed is shown in FIG. 4. As shown by a frame A in FIG. 4, a large number of stretching wrinkles are formed at a deep-drawn portion of the passenger assist handle part. When such stretching wrinkles are formed, no adjustment is possible, and the headliner thus molded results in defective products, which is large loss. Note that the “stretching wrinkle” is, for example, as shown in FIG. 4, a wrinkle formed due to a difference between a strongly stretched portion and the other portions. The “compression wrinkle” is a wrinkle formed by bunching at around the deep-drawn portion and the like.

As shown in FIG. 4, it can be inferred that in an example of using the glass mat as the fiber reinforcement layer, a large number of stretching wrinkles are formed because a very rigid part is formed due to a variation in the bundle of about eighty glass fibers, and in this part, the glass fibers do not smoothly slip against each other during molding but dig into the polyurethane of the base material.

To solve the problems described above, the following approaches were taken by using known glass fiber reinforcement materials to find a fiber reinforcement material as an alternative to the glass mat.

An approach was taken in which as an alternative to the glass mat, glass paper as disclosed in Patent Literature 2 was used as the glass fiber reinforcement material.

The glass paper is, in general, paper of glass filaments having line diameter of about 9 μm to about 13 μm and a length of about 6 mm to about 12 mm formed into a sheet form by a papermaking method. To maintain the strength of the molded headliner, a grammage of about 30 g/m² is sufficient. However, unlike the glass mat, the glass paper is not in the form of a mesh but is in the form of cloth. Therefore, the glass paper tears at a raised portion, such as the A-pillar part, having a highly contoured shape and cannot serve as a product.

Moreover, at the deep-drawn portion, the glass paper has a stronger bonding than the glass mat, and therefore, a severe “stretching wrinkle” is formed, which makes a serious defect in the top layer which is a designed surface. Note that around the deep-drawn portion, a “compression wrinkle” is formed, but the glass paper itself is thin, and therefore, the compression wrinkle has no significant influence over the top layer.

Then, an approach was taken in which an affixed product including a glass mat and glass paper affixed to each other as disclosed in Patent Literature 3 was used as the glass fiber reinforcement material.

As shown in Patent Literature 3, the “stretching wrinkle” and the “compression wrinkle” during molding were significantly reduced, but due to a slight product variation in the affixed product including the glass mat and the glass paper affixed to each other, perfect products all having no wrinkle during the molding could not be manufactured, and several percent of products had a subtle “stretching wrinkles” or “compression wrinkles”. Therefore, use of the method of Patent Literature 3 seems to be unsatisfactory for mass production.

Therefore, knowing that when the three types of fiber reinforcement materials described above are used to manufacture the molded polyurethane headliners, the defects formed as described above are observed at the deep-drawn portions, the inventors further studied to obtain a fiber reinforcement material causing no defects, “stretching wrinkles” or “compression wrinkles”, in the case of the glass paper used as the fiber reinforcement material.

In pursuing the glass paper, the inventors shifted their perspective, and focused not on the glass fibers themselves but on a binder bonding the glass fibers. The inventors assumed that if a binder bonding the glass fibers of the glass paper to each other exhibits flowability upon heating during the molding to allow the glass fibers bonded together to be displaced with respect to each other while bonding the glass fibers to each other, a molded product would be provided without the “stretching wrinkles” or “compression wrinkles” formed during the molding.

Thus, to which extent stretching is required for the headliner as a molded product was determined through experiments. An existing molded headliner including a glass mat as the fiber reinforcement material was used in the experiments. The experimental data is shown in FIGS. 5A to 5C. FIGS. 5A to 5C are photographs showing a change in ruled lines of a grid of a molded headliner including a headliner top layer with the ruled lines drawn at 20 mm intervals in advance before molding. FIG. 5A shows part of the molded headliner after molding. Portions with significant dimensional change in FIG. 5A are shown in FIGS. 5B and 5C as enlarged views of FIG. 5A. The dimension of the ruled lines of the grid drawn on the top layer shown in FIGS. 5B and 5C was 22 mm (about 10% stretched) at maximum and was about 21 mm to 21.5 mm (5% to 7% stretched) in other portions with a significant change. As a result, it was found that a stretch of 22 mm, that is, about a stretch of 10%, is required at maximum.

To satisfy the above-described idea, the inventors considered if, instead of a binder for simple binding, a material (referred to as a “slip-property imparting binder material” in the present disclosure) is used to glass fibers which barely stretch, and the material is softened by the heat of a hot press used for molding in the course of molding a polyurethane headliner to loosen the bonding between the glass fibers and to enable the glass fibers to slip against each other, glass paper can be produced in which the glass fibers appear to stretch.

That is, in the case of existing glass paper, the glass fibers in the existing glass paper are not displaced with respect to each other even when the glass paper is heated, and therefore, the existing glass paper cannot conform to a surface change during molding, a large stretching wrinkle is formed, and the existing glass paper eventually tears and cannot be a product. However, the inventors proceeded with their studies with the determination that smooth displacement of glass fibers with respect to each other would allow the glass fibers to conform to the surface change, and even if stretch (in practice, the displacement of the glass fibers with respect to each other) were not satisfactory for the surface change, the compression wrinkle would be easily crushed by a forming mold when the degree of the compression wrinkle were low because of a much less thickness of the glass paper than the glass mat, and the compression wrinkle would have no influence on the quality of a product.

The present disclosure has been thought of as a result of the above-described study. The present disclosure is primarily directed to a fiber reinforcement material used for a thermoformed product which is a product thermoformed in a mold, and the like, the fiber reinforcement material including glass paper and being configured to suppress a stretching wrinkle and the like from being formed, even in deep-draw forming, despite including the glass paper.

### SUMMARY

According to an aspect of the present disclosure, a fiber reinforcement material used for a thermoformed product which is a product thermoformed in a mold includes: glass paper including glass fibers as a main material; and a slip-property imparting binder material adhering to the glass paper, the slip-property imparting binder material not only having an adhesion function of bonding the glass fibers of the glass paper to each other but also softening, during thermoforming of the product, to enable the glass fibers to be displaced with respect to each other to conform to a shape of the mold used in thermoforming the product such that the glass fibers slip against each other to suppress a stretching wrinkle or the like from being formed.

A first aspect of the present disclosure is a fiber reinforcement material used for a thermoformed product which is a product thermoformed in a mold, the fiber reinforcement material including: glass paper including glass fibers as a main material; and a slip-property imparting binder material adhering to the glass paper, the slip-property imparting binder material including a thermoplastic resin, the thermoplastic resin softening, during thermoforming of the product, to enable the glass fibers to slip against each other to conform to a shape of the mold used in thermoforming the product, the thermoplastic resin solidifying after the thermoformed product is cooled.

In a second aspect referring to the first aspect, the slip-property imparting binder material is in powder form.

In a third aspect referring to the second aspect, the slip-property imparting binder material in powder form adheres to the glass paper.

In a fourth aspect referring to the third aspect, the slip-property imparting binder material has a melting point of 80 °C to 110 °C and a melt flow rate (MFR) of 50 g/10 min to 150 g/10 min.

In a fifth aspect referring to the third aspect, the slip-property imparting binder material includes an ethylene-vinyl acetate copolymer resin as a main component.

The sixth aspect is a method of manufacturing the fiber reinforcement material of the first aspect, the method including: making the glass fibers into the glass paper; causing a slip-property imparting binder material to adhere to the glass paper; and thereafter drying and then thermally treating the slip-property imparting binder material to bond the glass fibers to each other by the slip-property imparting binder material.

In a seventh aspect referring to the sixth aspect, the slip-property imparting binder material is in powder form, and the method includes scattering the slip-property imparting binder material in powder form toward an outer surface of the glass paper.

An eighth aspect is a molded vehicle headliner including the fiber reinforcement material of the first aspect, the molded vehicle headliner including: a base material layer including rigid polyurethane foam; a first fiber reinforcement layer and a second fiber reinforcement layer bonded to opposite sides of the base material layer, respectively; a top layer bonded to an outer side of the first fiber reinforcement layer; and a back surface layer bonded to an outer side of the second fiber reinforcement layer, wherein at least one of the first fiber reinforcement layer and the second fiber reinforcement layer includes the fiber reinforcement material.

A ninth aspect is a method of manufacturing the molded vehicle headliner of the eighth aspect, the method including: forming a multilayer structure by providing a polyurethane-based adhesive between the base material layer and the first fiber reinforcement layer and between the base material layer and the second fiber reinforcement layer and further stacking the top layer on the outer side of the first fiber reinforcement layer and the back layer on the outer side of the second fiber reinforcement layer; heating and compressing the multilayer structure by using a hot press to cause the slip-property imparting binder material included in the fiber reinforcement material to flow and the glass fibers to slip against each other to conform to a final shape of the molded vehicle headliner such that the multilayer structure is molded to have a shape of the molded vehicle headliner; and then cooling the multilayer structure to solidify the slip-property imparting binder material and the polyurethane-based adhesive to integrate the base material layer, the first fiber reinforcement layer, the second fiber reinforcement layer, the top layer, and the back layer with each other.

In the present disclosure, the slip-property imparting binder material includes the thermoplastic resin, the thermoplastic resin softening, during thermoforming of the product, to enable the glass fibers in the fiber sheet to slip against each other to conform to the shape of the mold used in thermoforming the product, the thermoplastic resin resolidifying after the thermoformed product is cooled. Therefore, the defects resulting in problems in existing glass mats and existing glass paper, that is, the stretching wrinkles and the compression wrinkles are suppressed from occurring, thereby reducing molded headliners that end up as defective products, or the like, after molding due to these defects.

### BRIEF DESCRIPTION OF THE DRAWINGS

FIG. 1 is a perspective view of a vehicle including a molded vehicle headliner;

FIG. 2 is a partial view of the molded vehicle headliner of FIG. 1;

FIG. 3 is a view illustrating a lamination state of a molded headliner used in FIG. 2;

FIG. 4 is a photograph of a perspective view of a part of a molded vehicle headliner including a known glass mat as a fiber reinforcement material viewed from a vehicle interior side;

FIGS. 5A to 5C are photographs showing a change in ruled lines of a grid of a molded headliner including a top layer, on which the ruled lines having been drawn at 20 mm intervals before molding, of the molded headliner, in the case of employing a fiber reinforcement material including a glass mat, wherein FIG. 5A shows part of the molded headliner after molding, and FIGS. 5B and 5C are enlarged views of parts of FIG. 5A;

FIG. 6 is a table showing results of a bend test and a tensile test of test pieces of fiber reinforcement materials of examples of the present disclosure and a comparative example;

FIG. 7 is a photograph of the test piece of the fiber reinforcement material of Comparative Example 1 vertically clamped before subjected to the tensile test;

FIG. 8 is a full-scale photograph of a portion, denoted by B, of the test piece in FIG. 7;

FIGS. 9A to 9C are photographs of the test piece of FIG. 7 subjected to the tensile test in an environment at 100 °C, wherein FIG. 9A is a photograph of the test piece before the tensile test, FIG. 9B is a photograph of the test piece pulled to a strain of about 5%, and FIG. 9C is a photograph of the test piece pulled to a strain of about 10%;

FIGS. 10A to 10C are photographs, which are similar to FIGS. 9A to 9B, of the test piece of Example 2 subjected to the tensile test in the environment at 100 °C, wherein FIG. 10A is a photograph of the test piece before the tensile test, FIG. 10B is a photograph of the test piece pulled to a strain of 5%, and FIG. 10C is a photograph of the test piece pulled to a strain of 10%;

FIG. 11 is a photograph of a test piece of glass paper, as a fiber reinforcement material, of Comparative Example 2 subjected to the tensile test in the environment at 100 °C; and

FIG. 12 is a photograph of a part, similar to the part of FIG. 4, of a molded headliner including the glass paper of Example 2.

### DETAILED DESCRIPTION

Embodiments of the present disclosure will be described in detail below with reference to the drawings. The description of the following preferable embodiments is substantially a mere example and does not intend to limit the present disclosure, or application products or applications of the present disclosure. Moreover, configurations not described in the present specification may accordingly employ well-known configurations.

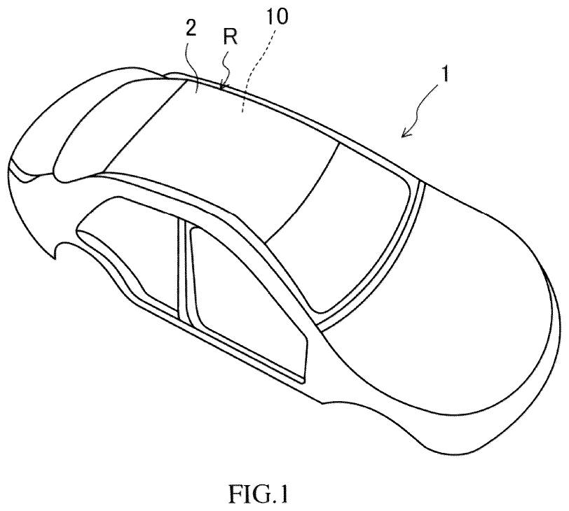

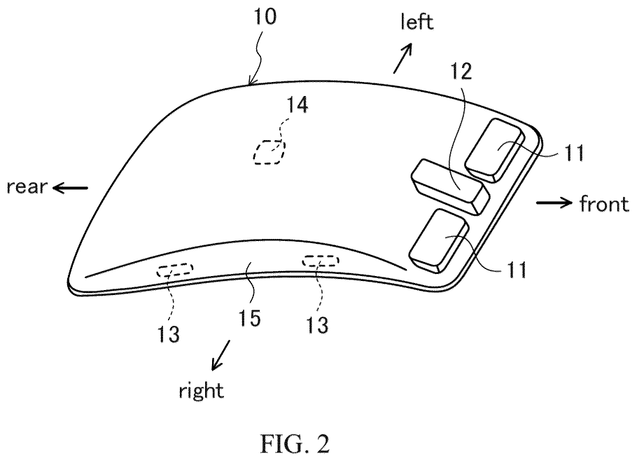

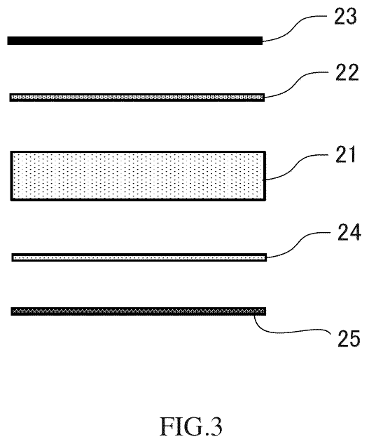

The present disclosure relates to a fiber reinforcement material used for a thermoformed product which is a product thermoformed in a mold. The present disclosure is preferably used as a fiber reinforcement material particularly for molded vehicle headliners. Therefore, the fiber reinforcement material of the present disclosure is described using a molded vehicle headliner as an example. FIG. 1 shows a vehicle 1 including a molded vehicle headliner 10 (hereinafter also referred to simply as a molded headliner) according to the present embodiment. FIG. 2 is a partial view of the molded vehicle headliner including the fiber reinforcement material according to the present embodiment. FIG. 3 is a view illustrating a lamination state of the molded headliner of FIG. 2. Note that in FIG. 1, a front part of the vehicle is shown on the right side and a rear part of the vehicle is shown on the left side.

As shown in FIG. 1, the molded headliner 10 is disposed on a vehicle interior side of a roof panel 2 of the vehicle 1 to serve as a designed surface of a vehicle interior ceiling. As shown in FIG. 2, the molded headliner 10 has a panel shape.

The molded headliner 10 has a substantially rectangular shape elongated in the front/rear direction of the vehicle and has a known panel shape. FIG. 2 is a perspective top view of the molded headliner 10, wherein the molded headliner 10 has a front part shown on the right side and a rear part shown on the left side. As shown in FIG. 2, the molded headliner 10 has recesses 11 (recesses as viewed from the vehicle interior, the same applies hereinafter) for sun visors and a recess 12 for an overhead console. The recesses 11 are formed at the front part on both the right and left sides. The recess 12 is formed between the recesses 11. A sectional view of this part is not shown, but this part is largely recessed from a general flat surface. Passenger assist handles denoted by 13 are disposed at both right and left lateral parts of the molded headliner 10. A room lamp is denoted by 14. The passenger assist handles 13 are provided at inclined parts denoted by 15. The recesses 11, the recess 12, the passenger assist handles 13, the inclined parts 15, and the like are deeply recessed and are thus parts where defects such as wrinkles and/or cracks are likely to be formed.

As shown in FIG. 3, the molded headliner 10 includes: a base material layer 21 including rigid polyurethane foam; a first fiber reinforcement layer 22 on the base material layer 21 at the vehicle interior side; a second fiber reinforcement layer 24 on the base material layer 21 at the side of the roof panel 2; a top layer 23 on the first fiber reinforcement layer 22 at the vehicle interior side, the top layer being formed from non-woven fabric; and a back layer 25 on the second fiber reinforcement layer 24 at the side of the roof panel 2.

Of the first fiber reinforcement layer 22 and the second fiber reinforcement layer 24, at least the first fiber reinforcement layer 22, in a preferable aspect, both the first fiber reinforcement layer 22 and the second fiber reinforcement layer 24, includes the fiber reinforcement material of the present disclosure. In a more preferable aspect, the first fiber reinforcement layer 22 and the second fiber reinforcement layer 24 consist of the fiber reinforcement material of the present disclosure. The fiber reinforcement material of the present embodiment includes: glass paper including glass fibers as a main material; and a slip-property imparting binder material adhering to the glass paper. The glass paper is a fiber sheet formed from glass fiber filaments. The slip-property imparting binder material adheres to a surface of the glass fibers included in the glass paper. During molding, the slip-property imparting binder material is influenced by a hot press temperature to bond the glass fibers to each other, while the slip-property imparting binder material enables the glass fibers to slip against each other while the glass fibers remain bonded.

The slip-property imparting binder material includes a thermoplastic resin, the thermoplastic resin softening, during thermoforming of a product (in the present embodiment, the vehicle headliner), to enable the glass fibers to slip against each other to conform to the shape of a mold used in thermoforming the product, the thermoplastic resin solidifying after the product is cooled. Therefore, the defects resulting in problems in existing glass mats and existing glass paper, that is, the stretching wrinkles and the compression wrinkles are suppressed from occurring, thereby reducing molded headliners that end up as defective products, or the like, after molding due to these defects.

Next, a method of manufacturing the molded headliner of the embodiment will be described. The method of manufacturing the molded headliner of the embodiment is the same as a general molding method, and the detailed description thereof is omitted. In a similar manner to conventional methods, the method according to the present embodiment includes: stacking the fiber reinforcement layer 22, to which a polyurethane-based adhesive has been applied, on one side of the base material layer 21 and the fiber reinforcement layer 24, to which the polyurethane-based adhesive has been applied, on the other side of the base material layer 21; and further stacking the top layer 23 on an outer side of the fiber reinforcement layer 22 and the back layer 25 on an outer side of the fiber reinforcement layer 24; and heating and compressing these layers by using a hot press to mold these layers into the shape of the molded headliner.

Next, the fiber reinforcement material included in the first fiber reinforcement layer 22 and the second fiber reinforcement layer 24 shown in FIG. 3 will be described.

The glass paper included in the fiber reinforcement material is obtained by, for example, scooping up glass fiber filaments dispersed in water in a similar manner to a method of making Washi, and drying the glass fiber filaments to form a fiber sheet including the glass fibers as a main material. Here, saying “including the glass fibers as a main material” means that the fiber sheet contains 40 wt % or more glass fibers. Moreover, the fiber reinforcement material of the present embodiment is obtained by: scattering the slip-property imparting binder material toward both the outer surfaces of the glass paper; and thereafter drying and then thermally treating the slip-property imparting binder material. In the fiber reinforcement material as described above, the slip-property imparting binder material bonds the glass fibers to each other and loosens their bonding state in a high temperature atmosphere to enable the glass fibers to slip against each other (to be displaced with respect to each other). In the present disclosure, “scattering” refers to scattering such that the slip-property imparting binder material enters between the glass fibers in the glass paper, adheres to surfaces of the glass fibers to facilitate a slip of the glass fibers against each other when the slip-property imparting binder material is heated later. “Scattering” includes the meanings of, for example, distributing, sprinkling, applying, spraying, and the like.

A low grammage of the glass paper of the present embodiment may result in insufficient strength as the fiber reinforcement material, whereas a high grammage of the glass paper of the present embodiment may result in an increased weight of a product. Therefore, the grammage of the glass paper of the present embodiment is preferably 20 g/m² to 100 g/m², particularly preferably 30 g/m² to 80 g/m².

The thickness (which is the mean thickness, the same applies hereinafter) of the glass paper is, for example, 1 mm or less. Moreover, the thickness of the glass paper is accordingly selected based on various aspects. When thin-type glass paper having a thickness of 0.2 mm to 0.4 mm is employed, the molded headliner is expected to have a reduced weight. Further, employing thick-type glass paper having a thickness of 0.8 mm to 1 mm can enhance the durability of the molded headliner. Furthermore, employing medium-type glass paper having a thickness of 0.5 mm to 0.7 mm can reduce the weight of the molded headliner while maintaining the durability of the molded headliner.

The diameter of the glass fibers included in the glass paper of the present embodiment is preferably 5 μm to 25 μm, particularly preferably 9 μm to 13 μm, as generally used. A minimum length of 3 mm is sufficient for the glass fibers to tolerate a maximum displacement of 10%. Moreover, as the length of the glass fibers increases, a longitudinal orientation (a direction in which the fibers are directed) becomes dominant, resulting in different longitudinal and lateral ratios of orientation, which leads to different longitudinal and lateral strengths of a product. Therefore, an increased length of the glass fibers is avoided as much as possible. A further increased length of the glass fibers leads to the problem of causing a trouble in making a sheet by a papermaking method. The maximum length is preferably 20 mm or less. In particular, the length of the glass fibers is preferably 6 mm to 12 mm.

Note that the fiber diameter and the fiber length are basically various, and not all of the fibers are within the ranges of the above-described numerical values, but most of the fibers are within the ranges of these numerical values. Not all of the fibers have to be within the range of the fiber length described above, but short fibers and/or long fibers out of the range may be included only in some parts. In that case, at least more than ⅓, preferably more than ½, of the total fibers fall within the range described above.

Instead of using only chopped strands of glass in producing the glass paper from glass fibers, some of the chopped strands of glass may be replaced with glass wool.

Moreover, since it is difficult to achieve a 100% glass fiber content in the glass paper in view of the papermaking method, a resin, such as a PET resin or LDPE, is preferably mixed to assist in the papermaking method. Note that the content of the glass fiber is preferably 40 wt % or more for the glass paper to function as a stiffener. Moreover, some glass wool and/or pulp may be added.

When an additional resin, such as a PET resin or a polyethylene resin, is mixed, moldability and rigidity can be improved. That is, in molding the headliner and the like, the additional resin serves as a slipping agent, and glass filaments readily slip as compared with the case of only the glass filaments. As a result, a tear of the glass paper during molding is effectively suppressed. The additional resin, such as a PET resin or a polyethylene resin, has excellent compatibility with a polyurethane-based adhesive (particularly, isocyanate-based adhesive) applied to the glass paper to tightly bond the base material and the glass paper to each other, and therefore, further enhanced adhesion is achieved, thereby improving the rigidity. A low content of the additional resin provides unsatisfactory effect, whereas a high content of the additional resin is uneconomical. Therefore, with respect to the total grammage of the glass paper, the content of the additional resin is preferably 0 to 60 wt %. To form the additional resin into fibers, the diameter and length of the fibers may be appropriately set, but when the diameter and length of the fiber are the same as those of the glass filaments, the production process of the glass paper is facilitated.

Examples of the slip-property imparting binder material for the fiber reinforcement material of the present embodiment include a thermoplastic resin having flowability at a temperature in the range from 80 °C to 120 °C. Specifically, a thermoplastic resin may be used which maintains the adhesion state of glass fibers to each other at the temperature range described above while providing the flowability to loosen bonding in the adhesion state to tolerate the displacement of the glass fibers with respect to each other. Therefore, also when the thermoplastic resin softens due to the temperature of the press mold during molding the headliner, and the glass fibers slip against each other and results in a relative displacement of 10%, a stretching wrinkle and/or a compression wrinkle is no longer formed. Note that the slip-property imparting binder material resolidifies by being cooled after produced into a product, and after the product is attached to a vehicle body, the slip-property imparting binder material is influenced by environmental conditions in which a temperature increases to almost 100 °C. However, the adhesive, such as isocyanate, applied to the stiffener during the molding of the headliner is an adhesive that is relatively less likely to soften than the slip-property imparting binder material during a temperature rise, thereby providing no trouble in maintaining the shape.

The melting point of the slip-property imparting binder material is preferably 80 °C to 120 °C in view of the temperature during hot pressing. In order for the slip-property imparting binder material to develop a slipping property, the melt flow rate (MFR) is preferably 50 g/10 min to 150 g/10 min, particularly preferably 70 g/10 min to 120 g/10 min. As the method of measuring the MFR, any well-known method is employed accordingly.

Moreover, when the slip-property imparting binder material is scattered onto outer surfaces of the glass paper, the slip-property imparting binder material is preferably uniformly scattered and enters between the glass fibers, and therefore, the slip-property imparting binder material is preferably in powder form including fine particles. In that case, the method of manufacturing the fiber reinforcement material includes the step of scattering the slip-property imparting binder material in powder form toward the outer surfaces of the glass paper. Moreover, when the slip-property imparting binder material is in powder form, the particle size of the slip-property imparting binder material is not uniform but varies, and the mean particle size is, preferably 500 μm or smaller, more preferably 100 μm to 450 μm, much more preferably 200 μm to 400 μm. As a specific example of the slip-property imparting binder material, a material including an ethylene-vinyl acetate copolymer resin (EVA) as a main component shows a good result. Here, “as a main component” means that the content of the resin is 95 wt % or more with respect to the total weight of the slip-property imparting binder material.

The amount of slip-property imparting binder material is preferably 10 g/m² per surface to be uniformly scattered onto a fiber sheet of glass fibers processed in paper form. In contrast, an excessive amount of the slip-property imparting binder material flows out of spaces between the glass fibers, and therefore, the amount of slip-property imparting binder material is preferably 50 g/m² per surface at maximum. The amount of slip-property imparting binder material is preferably 20 g/m² to 100 g/m², more preferably 30 g/m² to 80 g/m² in total of both the top and back surfaces.

In the present disclosure, when the fiber reinforcement material is applied as a fiber reinforcement layer to mold the headliner, the polyurethane foam, which is the base material layer, may have a sheet shape, and the polyurethane foam having a thickness of 3 mm to 12 mm is used. Examples of the top layer include polyolefin, polyester, polyamide-based woven fabric or non-woven fabric, a lamination top layer of tricot and slab polyurethane, knit fabric, a plastic sheet, and vinyl leather. As the adhesive applied to the fiber reinforcement layer, a commonly used polyurethane-based resin (e.g., isocyanate-based resin) is used. A large amount of the adhesive may result in a leakage of the adhesive, whereas a low amount of the adhesive results in insufficient adhesive strength, and therefore, the amount is preferably 10 g/m² to 30 g/m².

A method of manufacturing the molded vehicle headliner of the present embodiment is almost the same as the method of manufacturing an existing glass mat except that glass paper is used as the glass fiber reinforcement material in place of the glass mat, and therefore, the method of manufacturing of the molded vehicle headliner will be briefly described. A base material layer of polyurethane foam, a first fiber reinforcement layer of glass paper to which a polyurethane-based resin adhesive has been applied, a second fiber reinforcement layer of glass paper to which the polyurethane-based resin adhesive has been applied, a top layer material, and a back layer material are prepared. The first fiber reinforcement layer is stacked on one surface of the base material layer, and a second fiber reinforcement layer is stacked on the other surface of the base material layer. Then, the top layer material is stacked on an outer side of the first fiber reinforcement layer, and the back layer material is stacked on an outer side of the second fiber reinforcement layer, thereby obtaining a multilayer structure. Thereafter, the multilayer structure is disposed in a heated mold and is thermally compressed to integrate the layers with each other.

The polyurethane-based resin adhesive may be applied to (e.g., sprayed to) the base material layer instead of the fiber reinforcement layer, or may be applied to both the fiber reinforcement layer and the base material layer. Moreover, instead of applying the adhesive, the base material or the fiber reinforcement material may be immersed in a liquid bath of the adhesive.

In the embodiment, as described above, the fiber reinforcement material used for a molded vehicle headliner includes: glass paper including glass fibers as a main material; and a slip-property imparting binder material adhering to the glass paper. In the present embodiment, the slip-property imparting binder material softens due to heat during the thermoforming of the headliner to loosen the bonding between the glass fibers to enable the glass fibers in the glass paper to slip against each other to conform to the shape of a mold in thermoforming a product (in the present embodiment, the vehicle headliner). Therefore, even at a deep-drawn portion, a stretching wrinkle and/or a compression wrinkle can be eliminated, and a product, particularly molded headliner, which requires deep drawing can be manufactured.

Moreover, the fiber reinforcement layer includes the glass paper, and therefore, the weight of the fiber reinforcement layer is reduced as compared with the case where the glass mat is employed.

### Example 1

In Example 1 was employed glass paper containing: 50 wt % core-sheath PET resin; 5 wt % extra-thin PET resin; 34 wt % chopped glass strands having a fiber length of 6 mm; and 11 wt % glass wool. The grammage of the glass paper was 30 g/m². As the slip-property imparting binder material, a powder (product name: PR 2030M 30PASS) manufactured by TOKYO PRINTING INK MFG. CO., LTD. and having a melting point of 100 °C and a melt flow rate (MFR) of 70 g/10 min was used. The slip-property imparting binder material was sprinkled onto a top face and a back face of a fiber sheet of glass paper each at 10 g/m².

### Example 2

Example 2 is different from Example 1 in that the grammage of the glass paper was 50 g/m², and other specifications of the Example 2 were the same as those of Example 1.

### Example 3

Example 3 is different from Example 1 in that the grammage of the glass paper was 80 g/m², while other specifications of the Example 3 were the same as those of Example 1.

### Comparative Example 1

In Comparative Example 1, a glass mat was employed as the fiber reinforcement material. The glass mat was formed as follows: eighty or more glass filaments each having a diameter of 10 μm to 15 μm were bundled by using a sizing (filament coating) agent to obtain a fiber bundle of 0.8 mm to 1.5 mm, and the fiber bundle was cut to a length of about 30 mm to 80 mm, thereby manufacturing chopped strands, which were scattered in the shape of a mat and were formed into a mat by using a binder. As the fiber reinforcement material, a glass mat having a grammage of 100 g/m² was employed.

### Comparative Example 2

Comparative Example 2 is a test piece including the glass paper disclosed in Patent Literature 2 as the fiber reinforcement material. Specifically, the glass paper was manufactured by wet method using a papermaking machine as in general papermaking. That is, glass filaments having a diameter of about 11 μm and a fiber length of about 25 mm were dispersed and were scooped up, were made into the form of a paper, and were treated with a silane-based treatment agent, thereby making glass paper having a grammage of 50 g/m². Note that in Comparative Example 2, the slip-property imparting binder material of the present disclosure was not employed.

First of all, the test pieces of the fiber reinforcement materials of Examples 1, 2, 3, and Comparative Example 1 were measured in terms of bending property and stretch property to learn the degree of basic properties of these test pieces.

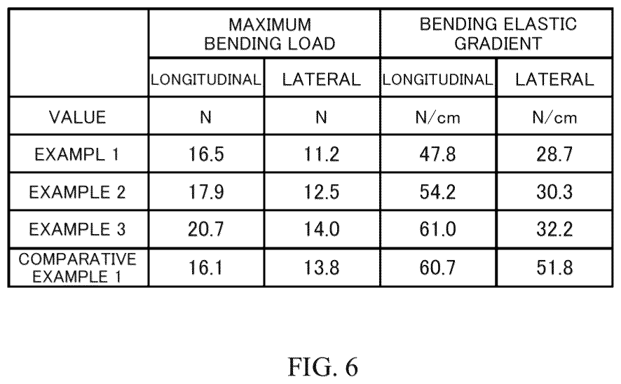

In the bend test, the test piece having a width of 50 mm and a length of 150 mm was placed on a support with a 100 mm span, the center of the test piece was pressed with a plate member having a width of 10 mm, and a load at which the test piece broke was measured. The results are shown in FIG. 6. The elastic gradient of bending was simultaneously measured, and the results are shown in FIG. 6. Note that ten test pieces were prepared for each of the examples and the comparative example, and the average thereof was calculated.

In general, in the molded headliner, a maximum bending load was greater than or equal to 10 N and the elastic gradient of bending was 25 N/cm, and values of the maximum bending load and the bending elastic gradient of all of Examples 1, 2, 3, and Comparative Example 1 were satisfactory values.

Next, in order to simulate a state with reference to which a situation of the fiber reinforcement material at a deep-drawn portion of the molded headliner can be visually checked, the test pieces of Comparative Example 1, Example 1, Example 2, and Example 3 clamped in a chuck of a tensile tester were placed in a high-temperature atmosphere testing box and were pulled in a bias (diagonal) direction. In practice, the test pieces of Example 1, Example 2, and Example 3 were pulled in three directions, namely, vertical (roll direction)/horizontal/bias (diagonal) directions, and each test piece was in a similar state in each pull direction. No significant difference was resulted even when the grammage differed. Therefore, only some photographs are shown here.

Moreover, a hot press mold of the molded headliner is at about 130 °C during molding, and during pressing, the temperature of the fiber reinforcement material increases at least to about 100 °C. Therefore, the atmosphere temperature in the testing box was set to 100 °C.

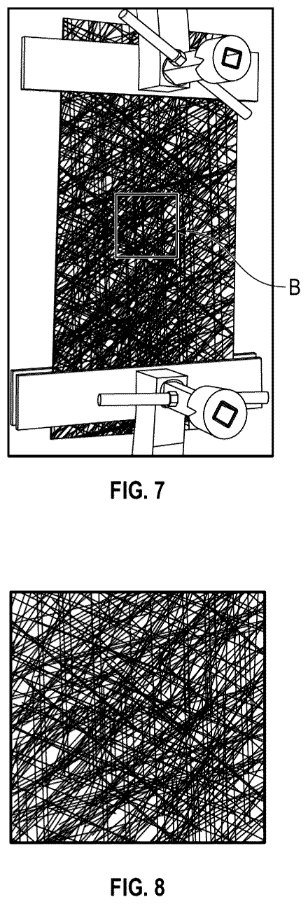

In the tensile test, a test piece having a width of 150 mm and a length of 300 mm was photographed with upper and lower ends thereof being held in the testing box at 100 °C with a chuck span (L) of 200 mm. FIG. 7 shows a photograph of a test piece of Comparative Example 1 clamped by a chuck of the tensile tester. FIG. 8 shows a photograph of a part of the test piece of Comparative Example 1 employed in the tensile test. FIG. 8 is a view of a part in a frame indicated by arrow B of FIG. 7.

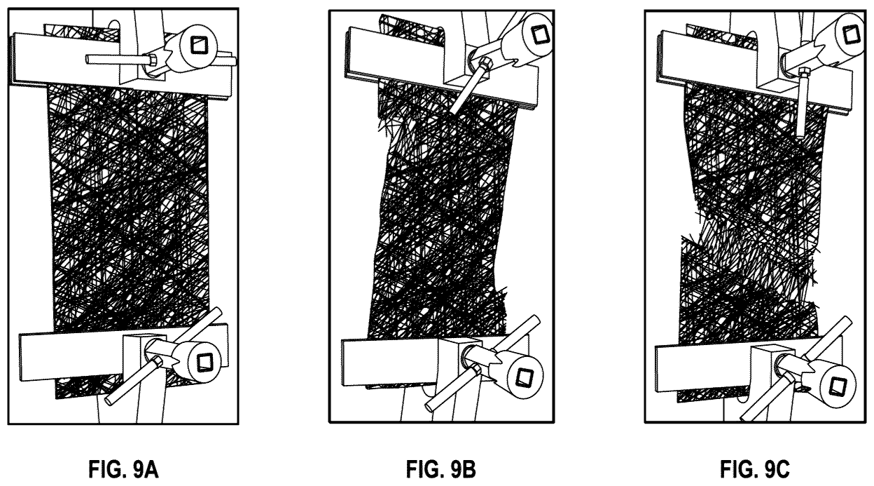

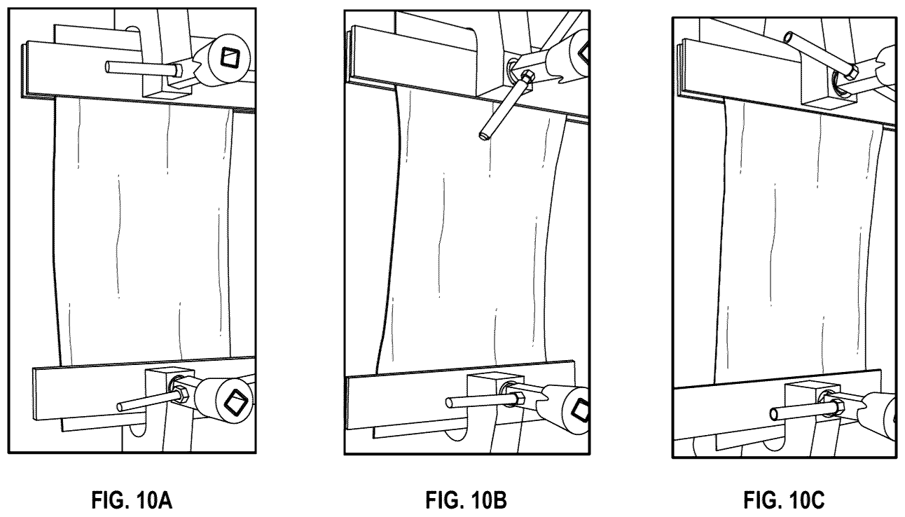

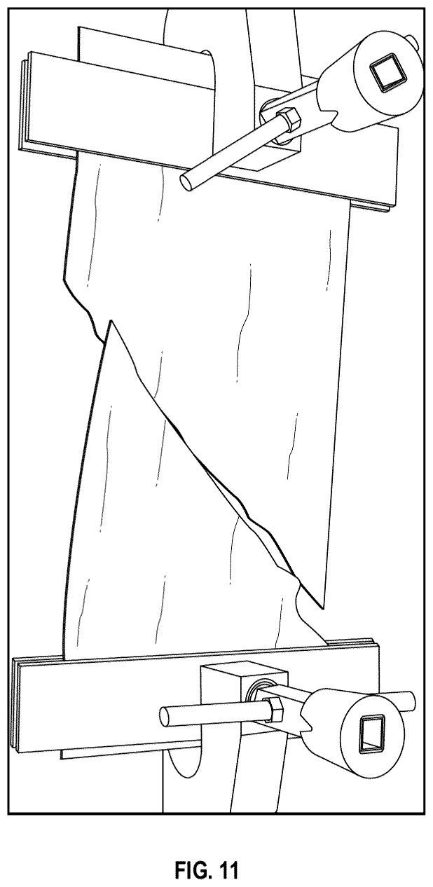

FIGS. 9A to 9C show an example of the test piece of the fiber reinforcement material, i.e., a glass mat, of Comparative Example 1. FIG. 9A is a photograph showing a state of the test piece at 0% strain in the tensile test, FIG. 9B is a photograph showing a state of the test piece at 5% strain in the tensile test, and FIG. 9(c) is a photograph showing a state of the test piece at 10% strain in the tensile test. FIGS. 10A to 10C show the test piece of Example 2 in similar states to FIG. 9. FIG. 11 shows a photograph of the test piece of the fiber reinforcement material of Comparative Example 2, that is, in the case of known glass paper (glass paper including no slip-property imparting binder material) at 10% strain in the tensile test.

FIGS. 9A to 9C show that in Comparative Example 1, in a state where the test piece was pulled to a strain of 5% in the tensile test, a wrinkle was formed and the test piece started to tear, and in a state where the test piece was pulled to a strain of 10% in the tensile test, the test piece was significantly broken. As can be seen from FIGS. 9A to 9C, the fiber reinforcement material of the glass mat of Comparative Example 1 can only be used for a molded headliner with a surface change rate of lower than or equal to 5% but cannot be used for a molded headliner, such as a deep-drawn molded headliner, with a significant change in shape.

Moreover, as can be seen from FIG. 11, the test piece of Comparative Example 2 tore at a strain of 10% in the tensile test and was separated into top and bottom large pieces. In Comparative Example 2, no slip-property imparting binder material was provided between sheets of glass paper, and therefore, when the test piece was subjected to a strain of 10% in the tensile test, glass fibers of the glass paper were torn, leading to the above-described result.

In contrast, in the fiber reinforcement material of the present disclosure, as can be seen from FIG. 10, no stretching wrinkle was formed, and no tear occurred in both at a strain of 5% and at a strain of 10% in the tensile test. It can be inferred that the reason for the above-described result of Example 2 of the present disclosure is that the slip-property imparting binder material was disposed between the glass fibers of the glass paper, and the slip-property imparting binder material exhibited flowability in an atmosphere heated to 100 °C, and therefore, the glass fibers with the slip-property imparting binder material therebetween could slip against (or be displaced with respect to) each other, and as a result, no stretching wrinkle was formed and no tear occurred, so that the result shown in the photograph was achieved.

Next, an example will be described in which the glass paper of Example 2 described above was used to manufacture a molded headliner.

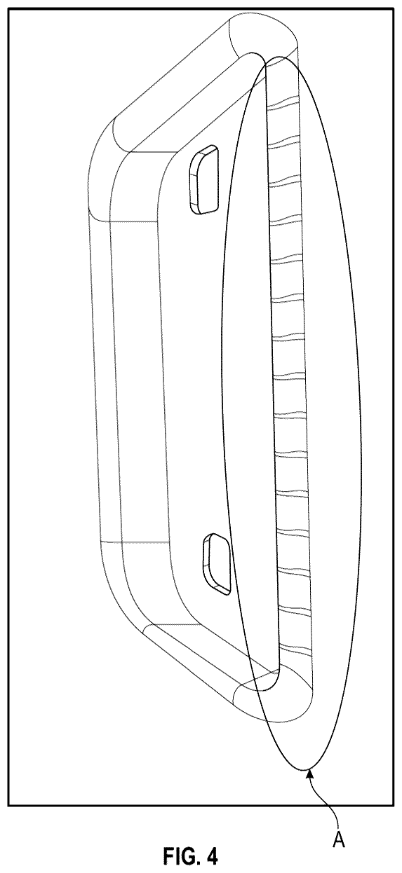

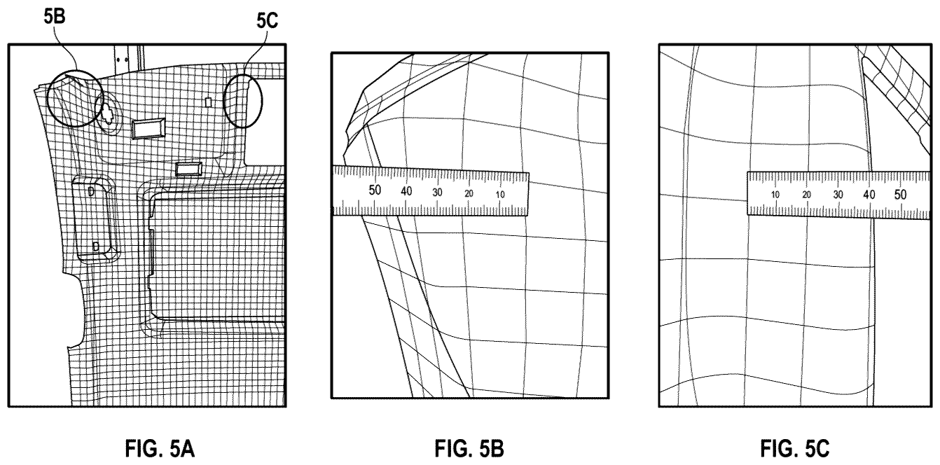

As a base material, a thermoformable rigid polyurethane foam sheet (1200 mm×1600 mm ×thickness 6.5 mm) having open cells of a weight per unit area of 195 g/m² was employed. As a top layer, non-woven fabric having a grammage of 180 g/m² was employed, and as a back layer, a back layer material of a general laminate including the non-woven fabric and a polypropylene (PP) film and having a grammage of 70 g/m² was employed. As the fiber reinforcement material, the fiber reinforcement material of Example 2 was employed. These materials were used to manufacture the molded headliner by a general method in a similar manner to FIG. 4.

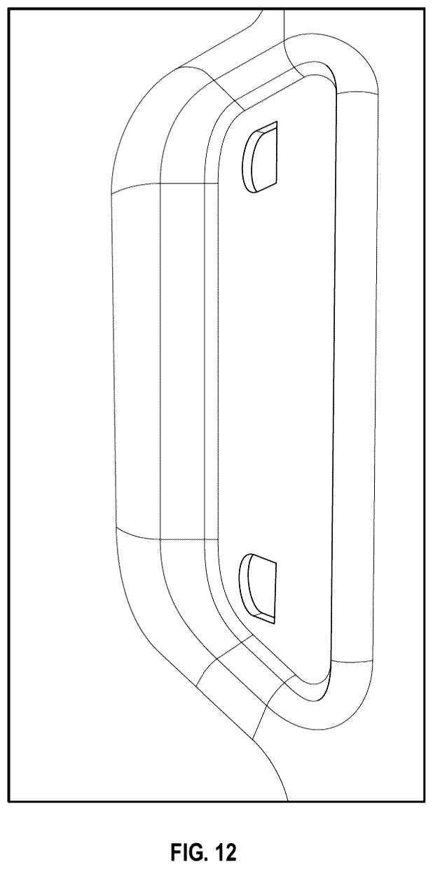

FIG. 12 shows a photograph of a part (the passenger assist handle part), the same part as FIG. 4, of the molded headliner including the fiber reinforcement material of Example 2.

FIGS. 4 and 12 were compared with each other. As can be seen from the photograph of FIG. 12, no wrinkle was formed in the fiber reinforcement material of Example 2 even at the deep-drawn portion, which is the passenger assist handle part. In contrast, as shown in FIG. 4, when the glass mat was used as the fiber reinforcement material, many wrinkles were formed and were defects clearly visible from the top layer side, and the molded headliner cannot be a product.

It can be inferred that the reason for such a difference thus caused is that when the glass mat of Comparative Example 1 shown in FIG. 4 was used, the glass fibers of the glass mat were molded without slipping, and therefore, for example, at the deep-drawn portion, such as the passenger assist handle, the change in the glass fiber layer was various, and many stretching wrinkles were thus formed.

In the embodiment, the glass paper including the slip-property imparting binder material was provided on the first fiber reinforcement layer 22 and the second fiber reinforcement layer 24. However, depending on the size of the molded headliner and/or the shape of the deep-drawn portion, the glass paper including the slip-property imparting binder material of the present disclosure may be provided only as the fiber reinforcement layer on the top layer side, and the fiber reinforcement layer on the other side may be an existing glass mat or existing glass paper.

The base material, the top layer material and the back layer material employed in the molded headliner of the examples described above are mere examples and should not be construed as limiting.

The present disclosure is applicable to fiber reinforcement materials including glass paper and molded vehicle headliner including the stiffeners.

What is claimed is:

1. A fiber reinforcement material used for a thermoformed product which is a product thermoformed in a mold, the fiber reinforcement material comprising:
glass paper including glass fibers as a main material; and
a slip-property imparting binder material adhering to the glass paper,
the slip-property imparting binder material including a thermoplastic resin, the thermoplastic resin softening, during thermoforming of the product, to enable the glass fibers to slip against each other to conform to a shape of the mold used in thermoforming the product, the thermoplastic resin solidifying after the thermoformed product is cooled.

2. The fiber reinforcement material of claim 1, wherein
the slip-property imparting binder material is in powder form.

3. The fiber reinforcement material of claim 2, wherein
the slip-property imparting binder material in powder form adheres to the glass paper.

4. The fiber reinforcement material of claim 3, wherein
the slip-property imparting binder material has a melting point of 80°C to 110°C and a melt flow rate of 50 g/10 min to 150 g/10 min.

5. The fiber reinforcement material of claim 3, wherein
the slip-property imparting binder material includes an ethylene-vinyl acetate copolymer resin as a main component.

6. A method of manufacturing the fiber reinforcement material of claim 1, the method comprising:
making the glass fibers into the glass paper;
scattering the slip-property imparting binder material toward at least one outer surface of the glass paper and causing the slip-property imparting binder material to adhere to the glass paper; and thereafter
drying and then thermally treating the slip-property imparting binder material to bond the glass fibers to each other by the slip-property imparting binder material.

7. The method of claim 6, wherein
the slip-property imparting binder material is in powder form, and
the method includes scattering the slip-property imparting binder material in powder form toward at least one outer surface of the glass paper.

8. A molded vehicle headliner including the fiber reinforcement material of claim 1, the molded vehicle headliner comprising:
a base material layer including rigid polyurethane foam;
a first fiber reinforcement layer and a second fiber reinforcement layer bonded to respective sides of the base material layer, respectively;
a top layer bonded to an outer side of the first fiber reinforcement layer; and
a back surface layer bonded to an outer side of the second fiber reinforcement layer,
wherein at least one of the first fiber reinforcement layer and the second fiber reinforcement layer includes the fiber reinforcement material.

9. A method of manufacturing the molded vehicle headliner of claim 8, the method comprising:
forming a multilayer structure by providing a polyurethane-based adhesive between the base material layer and the first fiber reinforcement layer and between the base material layer and the second fiber reinforcement layer and further stacking the top layer on the outer side of the first fiber reinforcement layer and the back layer on the outer side of the second fiber reinforcement layer;
heating and compressing the multilayer structure by using a hot press to cause the slip-property imparting binder material included in the fiber reinforcement material to flow and the glass fibers to slip against each other to conform to a final shape of the molded vehicle headliner such that the multilayer structure is molded to have a shape of the molded vehicle headliner; and then
cooling the multilayer structure to solidify the slip-property imparting binder material and the polyurethane-based adhesive to integrate the base material layer, the first fiber reinforcement layer, the second fiber reinforcement layer, the top layer, and the back layer with each other.
